(19) United States
(12) Patent Application Publication
(10) Pub. No.: US 2005/0096977 A1
(43) Pub. Date: May 5, 2005

(54) Method and system for paying decision makers for attention

(76) Inventor: Michael T. Rossides, Scottsdale, AZ (US)

Correspondence Address: MICHAEL T. ROSSIDES, 11167 E. MIRASOL CIRCLE, SCOTTSDALE, AZ, 85255, US

(21) Appl. No.: 10/700,836

(22) Filed: Nov. 3, 2003

(51) Int. Cl. G06F 17/60

(52) U.S. Cl. 705/14

(57) ABSTRACT

Disclosed is a method for operating a computer to pay one or more decision makers for attention. The method provides, via a computer, for an advertiser process in which an advertiser sets the terms of an offer to pay for the attention of a decision maker for an organization. The terms define a decision and a decision maker, an amount of money to be paid, and provide rules for specifying how payment is to be split if more than one person influences the decision. The method further provides recipient process in which one or more users accepts the offer and provisionally receives virtual payment. The method further provides an inspection process for inspecting the recipient(s) and paying him/them according to their role(s) in the decision, as revealed by the inspection, and according to the terms of the offer. The method can include sub-methods for deterring cheating, also disclosed.

### CROSS-REFERENCES TO RELATED APPLICATIONS

This application was preceded by the disclosure documents: 459,455 filed Jul. 26, 1999 (possibly now destroyed by USPTO), 481,613 filed Oct. 23, 2000 (possibly now destroyed by USPTO), 527,548 filed Mar. 11, 2003, and 531,657 filed May 19, 2003.

This application incorporates by reference U.S. application Ser. No. 10/042,975 filed on Jan. 7, 2002. application Ser. No. 10/042,975 was preceded by PCT application US/18715, filed on Jul. 7, 2000.

### STATEMENT REGARDING FEDERALLY FUNDED RESEARCH

Not applicable.

### BACKGROUND

1. Field of the Invention

This invention relates to methods and systems for paying people for their attention.

2. Description of Related Art

PCT application US/18715 and U.S. patent application Ser. No. 10/042,975 describe an invention entitled Expected Value Methods and Systems for Paying and Qualifying. The invention enables a user to pay a person for her for attention, provided she meets the qualification set forth by the user. The novelty of the invention centers on the payment method that has two stages, a virtual expected value (EV) payment, which may lead to a provisional payoff. If a recipient is owed a provisional payoff, the recipient is inspected to verify that she meets the qualifications of the offer. Thus, the recipient only receives actual payment upon a successful inspection.

The invention of Ser. No. 10/042,975 also described methods by which a user could pay an organizational decision maker, particularly a purchasing decision maker.

The present invention described in this application builds on the invention of Ser. No. 10/042,975 by disclosing additional, novel methods for paying organization decision makers for their attention, making the paying more efficient and less vulnerable to cheating.

In so doing, it includes methods that can be applied not just on top of expected value payment methods, but on top of other methods for paying for attention as well.

Many methods exist for indirectly paying decision makers for their attention, of course. These methods are not transparent, direct payments of definite monetary value. They are, instead, such things as buying tickets to sporting events, taking clients out to dinner, providing special perks of an endless variety. But it is highly uncommon to pay a definite amount of money to a decision maker for her attention because of the perceived “kickback” nature of such payments. (The invention of Ser. No. 10/042,975 obviated the kickback problem in a novel way be enabling payment for attention without the requirement to buy from the paying seller.)

The invention also provides a novel, highly cost-effective way to collect profiles of organizations with respect to who their decision makers are, and further, a novel, highly cost-effective way to collect profiles of the decision makers in those organizations.

With the possible exception of some of the methods disclosed in Ser. No. 10/042,975, the inventor is not aware of any existing methods and systems that perform the methods disclosed here or that provide the tangible results provided by the methods disclosed here.

### OBJECT OF THE INVENTION

The object of the invention is to provide a way to enable a user to efficiently pay one or more organization decision makers for attention to a message.

### BRIEF SUMMARY OF THE INVENTION

Disclosed is a method for operating a computer to pay one or more decision makers for attention. The method provides, via a computer, for an advertiser process in which an advertiser sets the terms of an offer to pay for the attention of a decision maker for an organization. The terms define a decision and a decision maker, an amount of money to be paid, and provide rules for specifying how payment is to be split if more than one person influences the decision. The method further provides recipient process in which one or more users accepts the offer and provisionally receives virtual payment. The method further provides an inspection process for inspecting the recipient(s) and paying him/them according to their role(s) in the decision, as revealed by the inspection, and according to the terms of the offer. The method can include sub-methods for deterring cheating, also disclosed.

### BRIEF DESCRIPTION OF THE DRAWINGS

There are no drawings.

### DETAILED DESCRIPTION OF THE INVENTION

Contents of this Specification

1. Introduction, Definitions, Scenarios and Applications
2. Processes for Improving the Paying of Purchasing Decision Makers (Org Realbuyers)
   a. Seller process
   b. Recipient process
   c. Inspection process
   d. Registering and additional data for use in an inspection
   e. Collecting and using profile data
   f. Report—seller feedback—process
3. Problems, Especially Cheats, that Can Arise in Paying Org Realbuyers
4. Preventing a User from Registering Multiple Identities for an Organization
5. Preventing a User from Impersonating a Decision Maker
6. Preventing a User from Exaggerating or Lying about His Role in a Purchase
7. Associating EV Payments with a Specified Purchase
8. Enabling Confidential Payment to Org Realbuyers
9. Broadening the Methods Disclosed to Enable the Paying of Any Decision Maker
10. Using Definite Rather than EV Payments within the Methods Disclosed

### 1. Introduction, Definitions and Scenarios

Introduction

The invention of this specification adds improvements to the methods of invention of U.S. application Ser. No. 10/042,975.

As discussed in the Brief Summary above the invention enables the paying of any kind of targeted decision maker for his attention. But in this specification, we will narrow the focus of the invention and focus on disclosing methods for paying a purchasing decision maker, that is, a person who fully or partially decides on a specified purchase.

We focus on this application of the invention because, of all the types of decision makers, we feel that the paying of purchasing decision makers for attention will have the largest impact.

That said, many of the methods disclosed can apply more broadly (see Section 9).

In the Brief Summary, we used the term advertiser to name a user who pays a targeted decision maker for attention. Advertiser is a very broad term that can refer to anyone who wants to communicate with a recipient. In this specification, we will usually use the term seller instead, not to narrow the meaning of the term, for seller is a generic term as well, but to evoke the idea that the method is being applied to paying purchasing decision makers.

U.S. application Ser. No. 10/042,975 describes a method and system that enable a user—called a seller in that application too—to pay a person on the verge of buying—a realbuyer—for his attention, whether that realbuyer is about to buy for himself or for an organization.

This specification will disclose methods for improving the payment of organization realbuyers, where the payments are made using the methods of U.S. application Ser. No. 10/042,975. Thus, in this specification, we assume that the methods disclosed here are applied within or “on top of” an existing payment method and system, especially as described in U.S. application Ser. No. 10/042,975.

Common problems arise in paying realbuyers buying for themselves and those buying for organizations. While we will mention certain of these common problems in this specification, we will focus on describing methods that solve problems special to paying organization realbuyers.

Definitions

Payment for attention to a specified message will mean payment for attention to any kind of specified message or messaging, including conversation messaging (e.g., payment for a phone conversation with a salesperson). By specified message we mean a message that is explicitly or implicitly specified in a payment offer.

A realbuyer (RB) is a person who buys a specified product or service within a specified period of time.

MPQ (Method for Paying and Qualifying) is the abbreviation we use for the inventive payment method of U.S. application Ser. No. 10/042,975. MPQ-RB is the abbreviation for the embodiment for paying realbuyers for their attention.

SPQ (System for Paying and Qualifying) is the abbreviation we use for the inventive system of U.S. application Ser. No. 10/042,975. SPQ-RB is the abbreviation we use for the embodiment for paying realbuyers for their attention.

An RB offer is an offer to pay realbuyers for their attention to a message.

An RB offer acceptance (also called an acceptance) is an acceptance of an RB offer by a user of the invention, as defined in U.S. application Ser. No. 10/042,975. The term acceptance is broad. Thus, the content and process of an acceptance will vary depending on the application and implementation.

Org is an abbreviation for organization.

An org buyer, org prospect (o-prospect) and a decision maker (d-maker) is a person who buys (purchases) for an org, that is, a person who makes or influences a specified purchasing decision.

A purchasing (buying) decision is any expenditure of money for a product or service.

An org realbuyer is someone who will make the decision to buy a specified product or service within a specified period of time for a specified org.

A recipient is a user who has received payment, whether a virtual EV payment, or a definite, actual payoff. Usually, though, recipient will refer to a user who has received a virtual EV payment. EV recipient and payoff recipient will sometimes be used to distinguish between two situations a user might be in regarding receiving payment.

A seller is a user who uses the inventive method to pay an organizational decision maker for attention. The term has broad application and can refer to anyone using the method to pay another qualified user for attention.

Paul will be used sometimes as a name to conveniently refer to a recipient of payment.

Sela will be used sometimes as a name to conveniently refer to a seller.

Verification data set means the set of all the data that the SPQ-RB registers/stores about a recipient for use in verifying whether that recipient is an org realbuyer or not, and for use in determining what role the recipient played in a specified purchase.

User profile means the compiled data about a recipient, including recipient registration data, verification data, and inspection result data (much of which can overlap).

Definition of a Pay-for-Attention Offer for Purchasing (“Realbuyer”) Decision Makers

U.S. application Ser. No. 10/042,975, incorporated by reference, defined a realbuyer (RB) as someone who buys, within a specified period of time, a product or service that is the subject of a pay-for-attention offer.

An RB offer for org realbuyers is basically this: A seller (advertiser) agrees to pay for the attention of a prospect associated with an org if two conditions hold:
1. the org buys a specified product/service within a specified period of time and,
2. the prospect is fully or partially responsible for deciding on the purchase.

A seller may pay the org itself but, we will assume that a seller pays a person or persons working for the org, just as an airline pays frequent flier miles to an individual.

Differently than in frequent flier programs, a payment to an org buyer is associated both with an individual and an org.

The individual's name must be part of the RB contract (an RB offer that has been accepted, als called an acceptance) because the system needs to identify him so that he can be paid, and so that an inspector can verify that he is a d-maker.

The recipient's org does not necessarily have to be part of the acceptance.

The proof-of-purchase will be in the org's name, however, and so the RB contract is implicitly or explicitly associated with an org. For example, an office furniture company may offer to pay Paul, a purchasing manager for IBM, if IBM buys 20 desks, and if Paul decides on the purchase.

Depending on implementation, an RB offer may be accepted by more than one person.

Definition of Expected Value Methods and Systems for Paying and Qualifying

The methods disclosed in the specification will add to the methods disclosed in U.S. application Ser. No. 10/042,975 to make the paying of org realbuyers more efficient and less vulnerable to cheating.

Although U.S. application Ser. No. 10/042,975 is incorporated by reference, let us still, for the sake of concreteness, include a definition of the basic inventive method of that application, applied to the transacting of realbuyer offers. This definition will resemble a claim.

The method is a method for using a computer to enable a user, called a seller, to pay targeted users for their attention to a message, comprising:
(a) a seller process for entering into the computer an offer stipulating that recipients who accept the offer will be owed a specified amount of money if they pay attention to a specified ad message, and if they satisfy a set of at least one target audience characteristics,
(b) said characteristics stated as a set of offer conditions by said advertiser,
(c) at least one of said conditions stating that to be eligible for payment, a recipient must purchase a product or service that is the subject of the offer within a specified period of time,
(d) said amount of money being a specified expected value (EV),
(e) presenting an interface to the public for enabling anyone to access and accept said offer,
(f) a recipient process for registering acceptance of said offer by a user, called a recipient, said acceptance entailing:
   e1. registering the recipient's identity and,
   e2. registering that the recipient has entered a request to be exposed to said specified message,
(g) said EV being paid via an EV payment bet including a Payoff,
(h) after registering said acceptance, executing said EV payment bet for said recipient with the probability of said recipient winning set at EV/Payoff,
(i) if, and only if, said recipient wins said bet, passing the winning result to an inspection process for determining whether said recipient satisfies said offer conditions,
(j) based only upon a positive determination by said inspection process, notifying a payment process for providing the Payoff to said recipient,
   whereby a seller pays a specified amount of money only to qualified, targeted recipients who are about to buy a specified product/service in exchange for their attention to a specified message.
   Illustrative Scenarios

To illustrate the methods disclosed we assume that MPQ-RB is implemented within a pay-for-placement directory in which search terms (criteria) describe the subjects of RB offers.

To better understand the methods described, it may help to have concrete situations in mind. So let us give scenarios below, which we will refer to on occasion for illustration purposes.

As an example scenario, assume an o-prospect enters the terms office space, 1234 Main Street into the directory, and finds an offer or offers. We will assume that means the offering seller(s) are offering to pay him for his attention provided his org, under his direction, purchases (buys or rents) space at 1234 Main Street within a specified period of time.

As another scenario, assume an o-prospect enters the terms janitorial services, and finds an offer or offers, we will assume that means the offering seller(s) are offering to pay him for his attention provided his org, under his direction, purchases janitorial services within a specified period of time.

As another scenario, assume an o-prospect enters the terms Toyota Prius, and finds an offer or offers. We will assume that means the offering seller(s) are offering to pay him for his attention provided his org, under his direction, purchases a Toyota Prius within a specified period of time.

As another scenario, assume an o-prospect enters the term PDA, and finds an offer or offers. We will assume that means the offering seller(s) are offering to pay him for his attention provided his org, under his direction, purchases a PDA within a specified period of time.

As a final scenario, assume an o-prospect, an investment manager for an insurance company, enters the term Triton CBO, and finds an offer or offers. We will assume that means the offering seller(s) are offering to pay him for his attention provided his org, under his direction, purchases (invests in) the Triton CBO within a specified period of time.

### 2. Processes for Improving the Paying of Org Realbuyers

As discussed, the invention of U.S. application Ser. No. 10/042,975 enables a user to pay org realbuyers for attention. The invention of Ser. No. 10/042,975 has three core processes, a seller process, a recipient process and an inspection process.

In this section, we divide the inventive methods of this specification according to these three processes, in sub-sections 2a, 2b, and 2d.

We also add a description, in sub-section 2c, of steps for registering data that can be registered during the recipient and/or inspection process.

Finally, in sub-section 2e we disclose how the invention can provide for the use of profile data that can be collected in the recipient and inspection processes.

### 2a. Methods that can be Included in the Seller Process

U.S. application Ser. No. 10/042,975 describes a seller process for entering an RB offer (see Definitions above). In this seller process, a seller defines an RB offer, which includes defining a particular purchasing decision (a purchase).

Here we disclose additional methods that can be incorporated into this seller process for improving the payment of org realbuyers.

The seller process can include steps for restricting the RB offer to d-makers in certain, specified orgs.

For example, assume that a seller of janitorial services can only handle cleaning the offices of smaller firms. So, the seller might want to restrict its RB offer to orgs that are smaller than a certain number of employees, or firms that have les than a certain amount of office space. As another example, assume that the seller of a Toyota Prius feels that its target market of orgs is taxicab companies. So, the seller might want to restrict its RB offer to taxi cab companies. There are endless ways to describe a target org, of course.

Accordingly, the invention can provide a method (or apparatus) for: enabling a seller to describe an org in any way—by type of product or service the org provides, by size, by sales, by number of employees, by location, or by any other category—such that the description restricts the RB offer to d-makers who work for orgs that fit the description.

The inventive system can provide a set of standard descriptions/definitions of an org that a seller can choose from in creating an RB offer.

A seller may also want to define an org realbuyer carefully, beyond simply, “We offer to pay the purchasing d-maker for a specified purchase.”

For example, an office landlord who has a building that competes with an office building at 1234 Main Street might want to only reach to chief executive officers or presidents of orgs that might rent space 1234 Main Street. So, the landlord might want to define a d-maker as chief executive officer or president.

There are many ways to describe a d-maker. One way is to define him by title. Thus, a seller can define a d-maker as anyone who holds a given title.

A seller may want to use a more qualitative definition, though. As examples, a seller might define a d-maker as:
“the person who is the most important person in an org for making a specified purchase,” or
“anyone with an important influence on a specified purchasing decision,” or
“the person who made the most recent, most similar purchasing decision for the org.”

Accordingly, the invention can provide a method (or apparatus) for: enabling a seller to enter a definition of an org realbuyer who is eligible for a payment for attention to a specified message for a specified purchasing decision. The definition can include a title or any kind qualitative description.

The inventive system can provide a set of standard org realbuyer descriptions/definitions that a seller can choose from.

An RB offer can allow more than one user to receive payment for attention for a single purchase, since more than one person will usually influence a purchase for an org (consider, for instance, the purchase of a textbook for a school system).

Thus, given an RB offer for org realbuyers, there may be multiple users—self-proclaimed d-makers—who accept the offer.

The seller's goal is to pay only certain d-maker(s) who genuinely influence the purchase. Moreover, the seller may only want to pay the d-maker(s) who influence the purchase the most. So, the seller will want to tailor/target the RB offer more than simply by saying the seller is offering to pay “the” d-maker. The seller will want to incent the right people to pay attention to the seller's message.

This targeting through incentives can be done by defining what portion of a payoff a d-maker will be paid according to his role in the purchasing decision. In other words, the seller can set forth rules for dividing an RB payoff among the d-makers who influence the purchase that is the subject of the RB offer. Such rules are highly variable and will depend on the aims of the seller.

Accordingly, the invention can provide a method (or apparatus) for: enabling a seller to enter, as part of an RB offer, rules for dividing a payoff among multiple d-makers, according to the roles those d-makers play in the purchase that is the subject of the offer.

We note that the meta-rules of the invention can include default definitions of a d-maker and default rules for dividing a potential payoff among multiple d-makers who influence a purchase. Such meta-rules can obviate the need to have sellers choose the division of a payoff. But, alternatively, the invention can provide a seller with a choice of setting the division rules.

Below we describe some specific rules that sellers can employ and that can be incorporated into the invention to make seller definitions easier.

We note that rules such as these, but not limited to these, can be provided as a set of standard choices that a seller can choose from. Standard rules make it easier for sellers to define an RB offer, and also make it easier for o-prospects to search RB offers according to how the payments offered are split among multiple d-makers.

Rule 1: Payment to Only one Person.

A seller can specify that regardless of how many people influence a decision, the RB payment will only go to one person. For example, assume Honda Motors is targeting RB offers to org realbuyers who plan to buy a Prius, and so offers to pay these realbuyers to look at a DVD about the Honda Civic Hybrid. And assume that five people in an org claim to both view the DVD and play a role in deciding which car the org will buy. Honda may restrict its offer such that it will only pay the person who exerts the most influence in the buying decision. That way, Honda may feel confident that the most influential decision maker will accept Honda's offer and be exposed to Honda's ad.

Accordingly, the invention can provide a method (or apparatus) for: enabling a seller to enter, as part of an RB offer, rules for dividing a payoff among multiple d-makers, such that only one person is eligible for the RB offer payoff.

Rule 2: Payment Proportional to Influence in Decision.

A seller can specify that any recipient of EV payment who goes on to provisionally win a payoff will receive a percentage of that payoff that corresponds to the “percentage of influence” that the recipient had in the purchasing decision. For example, a seller of interior design services, realizing that several people in a org might weigh-in on which design firm to hire, might offer to pay any “fractional d-maker” in an org for looking at the design company's website. But the design company might only want to pay a person proportionally to his influence in the hiring decision. Of course, “percentage of influence” is subjective and would need to be determined in the inspection process.

Accordingly, the invention can provide a method (or apparatus) for: enabling a seller to enter, as part of an RB offer, rules for dividing a payoff among multiple d-makers, such that a winner of an EV payment bet is eligible to receive a portion of the payoff proportional to the winner's role in the purchase that is the subject of the offer.

Rule 3: Payment Percentage by Category.

A seller can define categories of d-maker and assign percentages of the payoff to the categories. For example, a seller might define the categories of “most important d-maker,” “second most important d-maker,” “third most important d-maker,” and so forth, and assign a percentage of the payoff to each category. Thus, the first most important d-maker might be entitled to receive, say, 50% of the payoff.

As another example, a seller might define the category of “gatekeeper,” or “researcher,” realizing that some people in orgs have the job of doing initial research and screening of sellers. Therefore, it may be worthwhile for a seller to make the gatekeeper or researcher eligible for payment, even though that person does not make the final purchasing decision. A seller of janitorial services, for instance, might realize that the decisions about which firm to hire are generally made by upper level managers, but that lower level staffers often do the initial screening of vendors. Thus, the janitorial firm, not knowing the exact title in each org to reach, might define two categories of d-maker, a researcher and a final d-maker, and set forth the amount of payment each receives—the proportion of the payoff that each receives, that is.

(When sellers choose to pay according to d-maker categories, the method in effect enables a seller to offer multiple, discrete RB offers for the same purchase.)

(When sellers choose to pay according to d-maker categories, more than one user may accept an offer for a category, or claim part of a payoff for the same category. In this case, there will need to be rules for further sub-dividing the payoff per category.)

Category definitions are innumerable and will depend on the seller's aims.

Accordingly, the invention can provide a method (or apparatus) for: enabling a seller to enter, as part of an RB offer, rules for dividing a payoff among multiple d-makers, such that the seller defines categories of d-maker and corresponding percentages of a payoff, and such that a winner of an EV payment bet is eligible to receive a portion of the payoff as specified by the category that the winner fits in.

Rule 4: Letting the Users Decide how the Split a Payoff.

A seller can set forth a rule that the users in an org decide on the division of a payoff, provided that at all the important d-makers for a purchase accepted the RB offer, or provided that at least one major d-maker accepted the RB offer.

For example, a seller of investment services might realize that many people have input into which investment firm to choose, and so the firm might decide that the simplest, fairest way to divide a payoff is to let the people in the org do the division, with the proviso that all the major d-makers have accepted the seller's offer (and, therefore, have presumably been exposed to the seller's message).

Accordingly, the invention can provide a method (or apparatus) for: enabling a seller to enter, as part of an RB offer, rules for dividing a payoff among multiple d-makers, such that the users in an org decide how the payoff is split, provided that at least one recipient of EV payment is a genuine d-maker for the purchase that is the subject of the RB offer.

### 2b. Recipient Process for Org Prospects (Org Realbuyers)

U.S. application Ser. No. 10/042,975 described a recipient process for entering an RB offer (see Definitions above). This recipient process includes:
a recipient registration process,
an acceptance process, in which a recipient finds and accepts and RB offer (the acceptance process can include a search process),
a bet process, in which an EV payment bet corresponding to the offer is executed.

Here we disclose additional methods that can be incorporated into this recipient process for improving the payment of org realbuyers.

Recipient Registration Process

In order to pay an org realbuyer, the realbuyer's org does not necessarily have to be identified in advance of a purchase. It is possible that a user can simply identify himself as an individual to the system. He can then accept a realbuyer payment offer for his attention. Then, if he wins a realbuyer payoff, his identity can be verified and his purchase for an organization can be verified.

For example, if a recipient has responsibility for renting office space for IBM, it is not strictly necessary for him to pre-identify himself as an org buyer for IBM. He must prove this after the purchase, though, if he wins a realbuyer payoff.

So, the minimum registration form for an org realbuyer can be the same as for an individual realbuyer, i.e., ID data that uniquely identifies the individual.

However, it will often be useful in paying org realbuyers for a user to pre-identify the org that he is a purchasing decision maker for.

Accordingly, the invention can provide a method of (or apparatus for) including a recipient registration process that includes a field for enabling a recipient to enter the name of his org, in addition to his own identity. For example:
Organization: IBM
Purchasing Decision Maker: Paul Dix

Accordingly, when a recipient accepts a payment offer, the acceptance record includes the org's name and the recipient's name.

Thus, when an recipient wins an EV payment bet, the inspector can verify whether the org actually bought the product or service that was named in the RB offer. For example, if Paul accepts an RB offer in which he will be paid if his org rents office space at 1234 Main Street, then an inspector can verify whether:
(a) IBM rented office space at 1234 Main Street and
(b) Paul was a d-maker in the purchasing process.

Information entered in the recipient registration process can be stored in a user profile.

Multiple People May Accept Payment for a Single Purchase

As discussed, the invention can provide for enabling more than one person in an org to accept an RB offer for a purchase by that org. For example, five people make be involved in the decision to buy 20 desks for IBM, and each person can accept an RB offer regarding the desks.

Each acceptance is distinct, although they are associated with the same org. Therefore, each recipient of EV payment can potentially win a payoff. Depending upon the implementation, there may be multiple EV payment bets or a pooled bet of some sort.

Steps for Paying an Org Rather than Just the Org Realbuyer

If paying org realbuyers becomes common practice, then a significant percentage of orgs will have policies requiring that an org realbuyer pay all or portion of his payment to the org. For instance, this kind of policy will usually be the case where the org is a governmental agency, or under government contract.

The problem with paying an org, at least paying an org all of a payoff, is that it vitiates/eliminates the attraction of the RB offer for a recipient. If the org feels that there is some benefit to the org for having the org realbuyer accept RB offers, an org may allow an org realbuyer to personally collect a portion of the payoff.

Thus, the recipient registration form of the invention can include data for directing where payment should be sent, and for directing what percentage of a payoff should be sent to an org. This information can alternatively be provided in the inspection process (when a winning recipient provides information for transferring a payoff to himself or his org).

It is also possible that the invention can enable an org realbuyer to collect payment confidentially, to avoid detection by the org, that is. We disclose methods for accomplishing this object in Section 8.

Recipient Search Process

If RB offers are stored and made available through a directory, then the directory will include search means. The search means can enable a recipient to find offers not only according to the product or service being purchased, but also according to how the payoff is split. The exact phrasing of search choices/criteria will depend on the implementation and upon how seller offers are made, i.e., on the kinds of searchable offers the system enables sellers to make. Any of the types of offers described in sub-section 2a can be made searchable.

For example, a user might be able to enter the search criteria shown in italics below:
Product/service: 1234 Main Street and,
Rule for dividing payoff: proportional to influence

The search means can then show RB offers in which sellers are willing to pay for the attention of org realbuyers who purchase real estate (let us assume) at 1234 Main Street, and where the RB offers specify that the payoff will be divided proportionally according to the influence the user has exerted on the purchasing decision.

Accordingly, the inventive medium can include search means for enabling a user to find RB offers according to product/service and according to how the rules for dividing the payoff among multiple d-makers who influence the purchasing decision.

Using Two-Stage EV Payment Bets

We note that, as was described in U.S. application Ser. No. 10/042,975, the recipient process can include a two-stage (or multiple-stage) EV payment bet process. One purpose of two-stage process is to gather information from recipients who win the first stage. For example, after a recipient wins a first stage bet, he may be asked to submit some partial information validating/describing his role in the purchasing decision in question. In certain implementations of the invention, gathering information at this stage can be used to deter cheating.

### 2d. Inspection Process

U.S. application Ser. No. 10/042,975 described an inspection process for entering an RB offer (see Definitions above). In this inspection process, an inspector examines a provisionally winning RB claim by comparing the claimant's purchase data with the terms of the RB offer that the RB claim originated from.

Where an org realbuyer is concerned, the claimant's role in a purchase, not just the purchase itself, also needs to be inspected.

Here we describe steps that the invention can provide for making this inspection/verification process of org realbuyer claims effective.

In the inspection process, the inventive medium will provide for automatically asking the claimant for a set of data about the purchase that is the subject of the RB offer, and usually, additional data about the claimant himself (if that additional data has not been asked of the claimant before).

The information about the claimant is stored in a user profile that the inventive system creates about the claimant. This profile is filled with information registered about the recipient in all of the processes of the inventive method.

In the inspection process, an inspector will call up records stored by the SPQ-RB. These records will include:
1. The RB offer—the acceptance record—that the claim springs from,
2. The claimant's profile data, as registered in the recipient registration process, in the recipient acceptance process, in the current inspection process, and in previous inspection processes,
3. Possibly, profile data of other users who work for the same org as the claimant.

The inspector can also request a variety of additional information from the claimant as the inspection process proceeds.

After the inspector, through automated and personally initiated means, gathers as much information as he deems necessary, the inspector will then provide a judgment stating whether claimant deserves all or part of the payoff:
a. If the inspector determines no payment should be made then the inspector's statement can include commentary/instructions such as:
   i. whether the claimant intentionally tried to cheat
   ii. if the claimant did try to cheat, then also whether the claimant should forfeit all or part of any deposit that the claimant might have been required to make
   iii. an explanation of the inspector's judgment
b. if the inspector determines that the claimant deserves all or part of the payoff, the inspector's statement can include commentary/instructions such as:
   i. what percentage of the payoff the claimant is entitled to
   ii. an explanation of the inspector's judgment

Accordingly, the invention can provide a method (or apparatus) for: enabling an inspector to call up recipient registration data and additional recipient profile data collected during current and past inspection processes, and, profile data describing other users who work for the same org as the recipient.

Further, the invention can provide a method (or apparatus) for: entering a judgments about whether an org realbuyer claimant is to be paid part of the payoff corresponding to the claim, and if so, what percentage of the payoff is to be paid to the claimant, and if so, passing these instructions to a payment process for paying the claimant, who is then a validated org realbuyer for a particular, specified purchase.

This information about the recipient is stored in the recipient's profile, as is all the inspection data gathered to validate the recipient's role in the purchase.

We should also note that information gathered about a purported d-maker in an org can be used to validate or invalidate another purported d-maker's role. For example, assume a user, Paul, claims to be a senior vice president in charge of buying computers, and that this fact has been verified in an inspection. Then, assume that another user, Rob, who works for the same org as Paul, claims to be a manager in charge of buying computers. An inspector who finds Paul's profile may invalidate Rob's claim.

Accordingly, the invention method and medium can provide for cross-reference profiles of users who work for an org, such that an inspector can find any profile and use the information in the profile to verify the role of another user who works for the same org.

The cost of an inspection will vary, especially where orgs are concerned. One way of paying the cost is to assess a fee to claimants. This fee can be assessed upfront, or after the inspection, or on a cost per hour basis, billed periodically as the inspection proceeds. A fee can be custom or standard. The invention can provide for enabling an inspector to choose a particular fee schedule and corresponding type of inspection.

Separately, and importantly, the invention can also provide for paying/compensating anyone who contributes data in the inspection process, e.g., a salesperson. Thus, the invention can provide for enabling an inspector to assign a contribution and or an amount of compensation to a contributor.

Paying for the Inspection

An inspection of an org realbuyer may be quite costly. The inspection cost can be paid out of the claimant's payoff.

Accordingly, the invention can provide a method (or apparatus) for enabling an inspector to assess the costs of inspection and enter those costs in the inspection record. Then, the SPQ-RB can automatically deduct the costs, or a percentage of the costs from the payoff, and authorize the remaining amount to be paid to the claimant.

But, what if the claimant is rejected, meaning that no payoff is due. Who pays then?

As discussed in U.S. application Ser. No. 10/042,975, the claimant can be required to post a deposit, which is forfeit if he does not pass inspection. This deposit can be adjusted by the inspector, who can require additional funds, if the inspection requires.

A better way may be simply to assess a claimant an up-front inspection fee that is non-returnable. The fee can also be adjusted as the inspection progresses, to correspond to the costliness of the inspection.

Another way that inspection can be paid for is for the seller, or the medium the seller uses, to take an inspection overhead fee out of all EV payments or out of all payoffs. This fee may or may not be made visible to acceptors of RB offers, who may simply see their net payments—that is, their net EV payments, and/or their net payoffs.

There are many possibilities for paying for inspections, of course.

We note that the same principle applies to assessing a system fee so that the operators of SPQ-RB make a profit on the transactions, or simply so that the system overhead above and beyond inspections, can be covered.

### 2d. Registering and Additional Data for Use in an Inspection

The goal of an inspection of a winning recipient is not just to verify that a purchase has been made, but to determine and verify the extent of the recipient's role in the purchasing decision. A user who accepts EV payment and wins an EV payment bet, might have had little to no role in a purchasing decision, so facts about the recipient and the purchase may need to be collected.

To enable an effective inspection of recipients, additional information can be registered for use in the inspection process. We will call this information verification data since its purpose is to aid in the verification of a user's role in a purchase.

Verification data, partially described below, can be registered during different processes depending on the implementation:
It can be registered during the recipient registration process (in the recipient's ID record).
It can be registered during the acceptance process (usually just prior to an acceptance), for instance, as part of a search. For example, assume a user enters the term janitorial services into a directory for presenting RB offers; before or in conjunction with presenting offers, the directory can ask the searcher/recipient to enter information about his role in the purchasing decision; and the directory can store the searcher's response as part of the acceptance record, if the searcher accepts any of the RB offers presented.
It can be registered during the inspection process or any time after a recipient has won an EV payment bet, as part of a claim record.

SPQ-RB can enable a recipient to enter the following information—verification data—about a recipient (who purports to be a d-maker) to be stored for use in a potential inspection:
1. The recipient' statement that he is a d-maker for the purchase that is the subject of an offer that is presented or is to be presented. This statement be a recipient may be important because a recipient, especially a searcher, may be using the inventive system merely to view (be exposed to) offers, not in the role of a d-maker, but for some other purpose. If the recipient does not state his role, then an assumption must be made.
2. The recipient's title, position, and a more detailed description of the recipient's responsibilities in working for an org.
3. A qualitative description of the recipient's role in the purchase that is the subject of the RB offer that is accepted or to be accepted. For example, a user who is searching for web hosting services might state that he is a computer engineer who has input into the decision as to which hosting service is selected.
4. A percentage description of the recipient's role in the purchase that is the subject of the RB offer that is accepted or to be accepted. For example, a user who is searching for web hosting services might state that he is a computer engineer who is 30% in charge of the decision as to which hosting service is selected.
5. The identity(ies) of the recipient's supervisor(s), if any.
6. The identity(ies) of the other d-maker(s) who, along with the recipient, make the purchasing decision that is the subject of the RB offer.
7. The identity(ies) of the recipient's close colleagues.
8. Which location or division the recipient is purchasing for (if that is relevant).
9. Information about previous purchases that the recipient has been involved in, and the salespersons that dealt with the recipient in those purchases.

This information can be stored in the recipient's user profile.

Some information above can be entered once (with a user given the option to update his profile). Methods of registration will depend on implementation.

After the recipient wins an EV payment bet, and usually not before, the system can register data from the recipient about the salesperson who dealt with the recipient in the purchase that is the subject of the RB offer. That is, when a recipient reports that he made a purchase, the system can present to him means for also reporting whom he bought from, including the salesperson the recipient dealt with. This information enables an inspector to check with that salesperson.

After the recipient wins an EV payment bet, and usually not before, an inspector can request communication records between the org and the seller that a purchase was made from. A variety of communication can be used, of course. (The cost of examining and turning over such records may be worthwhile if a payoff is large enough.)

Separately, we note that the invention can provide for compensating anyone, such as a salesperson, who contributes information to be used in an inspection (see also sub-section 2c above describing the inspection process for org realbuyers).

Retrieving Acceptance and Claim Record Data

As a database, the SPQ-RB can store all of a user's acceptance and claim records so that they are findable according to:
a. the org that the user represents
b. a description of the purchase, especially, the name and category of the product/service.

These retrieval capabilities are important because an inspector may need to call up past acceptances and claims by users who represent an org, and especially according to product or service, in order to see who was the purported d-maker (org realbuyer) in the past for a product or service. Reviewing past records can validate or cast suspicion on a current claim.

For instance, if Paul claims to be the d-maker for the purchase of cars for his org, an inspector could look up acceptances and claims for that org according to the subject of cars. Then the inspector could see if someone else at the org did or did not say he was the d-maker regarding the purchase of cars, in the recent past.

Of course, d-makers change often at a typical org, vitiating some of the value of past records. Still, these records of past assertions can be crucial in uncovering cheating by users trying to falsely collect RB offer payments.

### 2e. Collecting and Using Profile Data

Collecting Profile Data About an Organization

As described in the previous sub-section 2d, the invention provides for registering a variety of information about a user who purports to be a d-maker. As noted, this information along with information gathered in the recipient registration process and in the inspection process can be used to create a profile of the user.

In fact, gathering information in the recipient acceptance process and in the inspection process is a novel, highly cost-effective way to gather profile data describing a user's role in making specified purchase decisions.

The SPQ-RB can enable individual user profile data to be grouped or searched by org name thereby creating, in effect, org profiles that provide information about who makes what purchasing decisions within named orgs.

The individual d-maker and org profiles can be used apart from the purpose of verifying a particular user's role in a particular purchase decision. These profiles can be utilized simply to find d-makers and direct payment to them for attention.

In other words, the SPQ-RB can enable a seller to search by organization and by particular type of purchase decision. For example, a seller might enter into SPQ-RB a query along the lines of:
Find verified (authenticated) decision makers matching:
Org: Scottsdale School Board
Purchasing Decision: Math Textbooks
   Using a Decision Maker's Profile

When a claimant has been inspected and has been validated as a d-maker for a purchase, the SPQ-RB stores that fact in the user's profile.

Once the claimant's role is authenticated, it may not need to be authenticated again, at least for a period of time.

This authenticated role can be valuable to sellers who can then offer to pay the authenticated d-maker a definite payment rather than an expected payment.

For example, a company selling janitorial services can pay for the attention of a d-maker who has been authenticated as the purchasing d-maker for, say, cleaning supplies or landscaping services.

Thus, the invention can also provide for paying org realbuyers with definite payments, according to their authenticated roles, as stored in their user profiles.

If an inspection yields only partially authenticated information, then this information can still be stored in the user's profile and can be used by sellers who might be willing to pay a discounted rate for the less well authenticated information.

### 2f. Report—Seller Feedback—Process

As described in U.S. application Ser. No. 10/042,975, the invention can provide for report processes that give sellers (advertisers) feedback to judge the cost-effectiveness of their pay-for-attention offers. Below we disclose additional report information that the invention can provide to sellers for evaluating RB offers made to org realbuyers:
1. A list of all the acceptances, and acceptors and their orgs. Sela can take this list and compare it to a list of her customers to determine which acceptors become purchasers who bought from her. For example, assume Sela, a car dealer selling Honda Civics, has made 200 RB offers to org realbuyers who plan to buy a Toyota Prius. She might find that 3 acceptor decided to buy a Honda Civic Hybrid instead from her.
2. A list of all acceptances and acceptors and their orgs, including the cost of each acceptance, including listing the product/service that is the subject of each offer/acceptance. Sela needs this cost data to determine whether her RB offers are cost-effective, that is, whether they are yielding enough in sales/profits to justify their cost. For example, Sela would like to know how much the 200 RB offers (imagined above) cost her to make. If they cost, for instance, $50 each, then that means a total cost of $10,000 to sell 3 cars.
3. A list of all acceptances and acceptors and their orgs split out by seller-defined category of realbuyer, and/or by realbuyer title, and/or by percentage role(s) in a purchase decision, and further including the cost of paying each category, each title and each role. Sela needs this cost data to determine the cost effectiveness of paying particular categories of org realbuyer and of paying for org realbuyers according to their influence in a purchase. Assume, for example, that Sela makes two different kinds of RB offer, one for “researchers,” and one for “the most important d-maker.” And assume that two out of the three sales imagined above stemmed from RB offers to researchers. That might tell Sela that paying researchers for their attention is worthwhile.
   Enabling a Seller to Find Out why Realbuyers did not Buy from the Seller

Sellers often do market research, asking many different kinds of questions, such as, What benefits do you seek in our product? and Why did you buy from us? The audience for such questions might be a focus group, which can be expensive to gather. Less expensive to poll is a seller's own set of customers.

One valuable market research question is: Why did you buy our competitor 's product and not our product?

This question needs to be posed to the customers of a seller's competitor. But, that list of customers is usually not available. Finding people on this list is sometimes possible with certain products and services, and given certain kinds of mailing lists, but generally it is hard for a seller to find out its competitor's customers, especially when the goal is to find the group of people who bought a highly specific product or service, for instance, a particular pair of shoes or industrial freezer or mutual fund.

The invention solves the problem of finding at least part of this customer set. In fact, the RB payment method of U.S. application Ser. No. 10/042,975 and this application provides perhaps the most efficient, general method for finding realbuyers who bought from a seller's competitor(s).

Here's how the method provides this audience. To illustrate, let us assume that a fund company, Janus, wants to know why companies chose a competitor, CGM Funds for 401(k) plans. So:
1. Janus uses the inventive medium to offer to pay org realbuyers who invest in CGM within a specified period of time.
2. A percentage of recipients who accept the offer will win the EV payment bets. Some of those winners will be claimants of the EV bet payoff.
3. Those claimants are the audience that Janus wants to reach, org realbuyers who have invested in CGM.

Now, to create a larger set of claimants, the inventive method can use a two-stage EV payment bet process in which the probability of winning the first bet will be much higher than if a single bet is used. The winners of this first bet will be asked if they are realbuyers and some percentage will be first-stage claimants. Those claimants are the audience that Janus wants to reach.

And so, the invention can provide for enabling a seller, who has paid a set of realbuyers, to ask those realbuyers why they did not buy from the seller and bought from the seller's competitor(s) instead.

The invention can enable any kind of communication between a seller and a realbuyer who has bought from a competitor. For instance, the invention can enable a survey completed via web form, or a phone conversation.

Accordingly, the invention can include a method (or apparatus) for enabling a seller to:
a. query claimants of an RB offer payoff with static questions or via a conversation,
b. to receive answers back from the claimants.

The invention can further provide for the seller to do one or more of the following:
c. select RB payoff claimants according to the product or service purchased,
d. pay RB payoff claimants for answers to market research queries,
e. pay only validated RB payoff claimants (claimants who passed inspection) for answers to market research queries,
f. ask payoff claimants, why did you buy the product/service you bought rather than our product/service? or an equivalent question.

### 3. Problems, Especially Cheats, that can Arise in Paying Org Realbuyers

EV payments for org realbuyers can be over $100 and payoffs may be $10,000 or more, amounts of money that will encourage users to cheat or “game” the system. Cheating by acceptors of RB offers will hinder the effectiveness of the methods described in Section 2. Therefore, the invention of Section 2 can be improved if it includes methods for deterring cheating.

The following cheating problems can arise:
1. A user may create multiple identities for a single org.
2. A user may impersonate a d-maker in cahoots with the real d-maker.
3. A user may exaggerate or lie about his role in a purchasing decision.

Sections 4-6 will describe methods the invention can include to deter these cheats.

Another problem that can arise in paying realbuyers is keeping track of EV payments.
4. That is, given multiple possible purchases by an org from a seller, and/or multiple possible ways to accept an RB offer for a purchase, how to determine which EV payments legitimately apply to a given purchase?

Section 7 will describe methods for keeping track of EV payments.

### 4. Preventing a User from Registering Multiple Identities for an Organization

The Problem

How to Prevent a User from Creating Multiple Identities for an Org?

A simple way to cheat the MPQ-RB is to create and register multiple names for a single org. The problem is that a proof-of-purchase—a receipt or purchase order, for instance—can spell an org's name in different ways. So a person could create multiple names for a single org and then collect EV payments under each name, and finally use a single receipt to collect a payoff in case any of the EV payments is a winner.

For example, assume that Paul registers: IBM, IBM Services and IBM USA. And assume he collects EV payments—that is, he accepts RB offers—under all three names for a single purchase of a Toyota Prius. So, he has three chances to win for this single purchase. Further assume, he buys a Prius, and that the receipt states his company's name as simply IBM Now, assume he wins an EV payment bet with the acceptance that used the name IBM Services. Next, he submits his receipt to an inspector and he claims that the name IBM on the receipt is the same org as IBM Services that is registered along with his winning EV payment.

The invention can include methods and features for preventing this cheat.

Methods for Solving the Problem

Simply registering the unique name (and possibly other ID data) of the recipient can be enough to solve the problem of multiple org names for a single org, because the number of org names associated with a recipient's name can be limited to one. During the registration process or the inspection process a recipient's name can be automatically searched to see if it is associated with more than one org with a similar sounding name. A recipient who has registered multiple similarly named orgs can be penalized. The problem then devolves to uniquely identifying an individual, which can be done in various ways, as discussed in the patent applications incorporated by reference, and as is well known-in the art.

Another solution to the problem is to have a rule whereby an org name must be registered with additional identifying information that will make the company ID data unique so that, upon inspection, or cross checking, it is clear that the same org has been registered under different names. Thus, the recipient registration form can include fields for entering, the org's name along with additional identifying data such as:
The org's tax ID number (or other government ID unique to that org).
The org's official name, legal name or name under its bank account
The org's bank name
The org's bank account number (or part of it)
The org's physical address
The org's web site or web domain
The org's email address
The org's phone number
The org's CEO or other top officer's

These data may be cross-checkable automatically by a computer to find matches. Or they may be cross-checkable by a human, in the inspection process, if a recipient has won an EV payment bet. Multiple names for the same org can then be disqualified.

Therefore, in addition to registering the data above, the MPQ may include processes for cross checking these data with the data already in the SPQ's database of orgs. Upon finding two orgs with matching data, indicating the same org registered under different names, the system can flag the names so that a system operator can, possibly, disqualify one or more of the orgs, and possibly the recipient who registered them.

But, in some cases, a user will legitimately be a d-maker for orgs with similar names, especially in the case of an org with multiple divisions or locations (see below).

Multiple Legitimate Identities for an Org that has Autonomous Divisions

Often, an org will have multiple divisions that are autonomous in the sense that they make purchasing decisions independently. In this case, two or more orgs with the same name is legitimate. So, the MPQ-RB can include methods for accommodating this situation.

One way to deal with autonomous divisions is to require that a user who claims to be a d-maker has to register the name of his org plus the particular division. In this case, EV payments to him correspond to the division, which is a distinct org in and of itself that can be dealt with distinctly from the larger org. Purchases for that division then may, perhaps, have to be delivered to that division to qualify for an EV payment and payoff.

For example, a purchasing d-maker for the GE Plastics division can be required to register his org as GE Plastics, rather than just GE.

Accordingly, the recipient registration process can includes the steps of entering the name of the recipient's org and the division the recipient makes purchasing decisions for.

Multiple Legitimate Identities for an Org that has Autonomous Locations

Often, an org will have multiple locations that are autonomous in the sense that they make purchasing decisions independently. In this case, two or more orgs with the same name is legitimate. So, the system can include features for accommodating this situation.

One way to deal with autonomous locations is to require that a user who claims to be a d-maker has to register using the name of his org plus the particular location. In this case, EV payments to him correspond to the location, which serves as a distinct org in and of itself that can be dealt with distinctly from the larger org. Purchases for that location then may, perhaps, have to be delivered to that location to qualify for an EV payment and payoff.

For example, a purchasing d-maker for the Mayo Clinic in Scottsdale can be required to register his org as Mayo Clinic Scottsdale, rather than just Mayo Clinic, if he makes purchasing decisions for the Mayo Clinic Scottsdale, but not other branches of the larger org.

Accordingly, the recipient registration process can include the steps of entering the name of the recipient's org and the location of the org where the recipient makes purchasing decisions.

Enabling a Recipient to Claim Payment for More than One Org or Sub-Org

Now, it is possible that a d-maker sometimes make purchasing decisions for multiple divisions or locations, and also for the larger organization. Thus, it is also possible as part of the recipient registration process, the MPQ can include the steps of registering that the d-maker has responsibility for multiple divisions or locations of an org, and for specifying those sub-orgs.

Alternatively, in the recipient acceptance process—the process for accepting an RB offer—the MPQ can include steps for enabling the recipient to enter which sub-org he is buying for. The sub-org is recorded as part of the acceptance record, to be checked in the inspection process, in the event that the recipient wins the EV payment bet for that acceptance.

For example, assume Paul has responsibility for buying office supplies for Mayo Clinic Scottsdale and Jacksonville. And assume he searches and finds RB offers of companies that sell office supplies. During the RB offer acceptance the SPQ-RB can enable him to declare which location he is buying for. Assume he enters Mayo Jacksonville. Then, if he buys supplies for Mayo Scottsdale, he will not be able to use a receipt for that purchase to collect on a winning EV acceptance (virtual payment) that lists Mayo Jacksonville as the org.

### 5. Preventing a User from Impersonating a Decision Maker

The Problem

How to Stop a User in Cahoots with a D-Maker from Impersonating that D-Maker?

Sela wants to pay for the attention of a genuine d-maker, such as the CEO of a company. It is possible for an employee (or other person) to impersonate a real d-maker, in the sense of assuming that d-maker's identity. For instance, assume Paul is the CEO and he has an assistant named, Bill. Bill knows about certain upcoming purchases. So, with Paul 's permission, he pretends to be Paul and accepts numerous RB offers. Eventually he provisionally wins a payoff. He and Paul plan to split the proceeds, even though Paul was not exposed to any of the messages required by the RB offers that Bill accepted.

Methods for Solving the Problem

The impersonation cheat is easy to stop if the real d-maker does not want it to take place because it will be revealed in the verification/inspection process. Or it can be revealed if there is a double registration, once by the real d-maker and once by the impersonator. But, if the real d-maker is in cahoots with the impersonator, the cheat is harder to stop.

Different authentication processes can be incorporated into the invention to deter and reveal this cheat. We describe certain ones below. We note that an advantage of the inventive method is that authentication does not have to take place at the time of acceptance of EV payment (the time of exposure to an ad message). Instead, the method can provide for capturing authentication data for later inspection, as described below.

Impersonation when Claiming a Payoff

One way an impersonator can succeed is to assume the d-maker's identity in the inspection process (as well as in the recipient process). We will assume that an inspector has means to discover the claimant's true identity, and that this cheat will not work. For example, we assume that in the inspection process an assistant would not be able to pass himself off as an executive.

Biometric Solutions

It is often possible to capture biometric information from the recipient of an ad message.

In the case where a recipient is communicating on the phone with the seller or is listening to a message on the phone, the system can include means for capturing a voiceprint of the recipient. This voiceprint can be stored to be associated with the specific payment for attention to that audio or phone-conversation message.

This can happen, for instance, if the phone call passes through a data-capturing switch that can record a call, and that can, further, store the recorded data and then provide the data to the SPQ. The SPQ can then use this data by providing it to an inspector in the inspection process, if the recipient wins the EV payment bet. In the inspection, the real d-maker would be inspected. The real d-maker would have to provide a voiceprint. This voiceprint would be stored and compared with the impersonator's print. The mismatch would be found, revealing the cheat.

Accordingly, the invention can provide a method (or apparatus) for:
associating an EV payment contract with a call connected between the recipient of the payment and a seller,
during the call, capturing a voiceprint of the recipient,
storing the voiceprint and associating it with the EV payment contract,
if the recipient wins the EV payment bet, and claims the payoff
   finding the stored voiceprint associated with the contract (bet),
   capturing a separate voiceprint of the claimant of the payoff,
   comparing the voiceprint of the claimant with the voiceprint of the call,
   if there is a match, providing the payoff to the claimant,
   if there is a mismatch, rejecting the claimant's claim,
   storing the rejection for possible further processing.

The same method applies if other biometric data are captured. These other data may be more appropriate if the recipient is viewing a webpage or video ad. In this case, it is still possible to use voiceprints if the system periodically surprises the recipient by asking him to immediately call a number to provide a voiceprint that is associated with the EV payment that the recipient is receiving for viewing a webpage or video.

If the user is viewing a webpage or video, it is more likely, perhaps, to capture other kinds of biometric data, such as having the recipient provide a short typing sample that could be unique for its pattern of keystrokes, or speed, or by some other analysis. It is also possible, as digital cameras become widespread to have the recipient provide a digital picture of himself that the system stores for verification in the inspection stage.

Accordingly, the invention can provide a method (or apparatus) for:
associating an EV payment contract with the viewing of a message by a recipient,
during the viewing, capturing biometric data from the recipient,
storing the biometric data and associating it with the EV payment contract,
if the recipient wins the EV payment bet, and claims the payoff,
   finding the stored biometric data associated with the contract (bet),
   capturing separate biometric data of the claimant of the payoff,
   comparing the biometric data of the claimant with the biometric data of the call,
   if there is a match, providing the payoff to the claimant,
   if there is a mismatch, rejecting the claimant's claim,
   storing the rejection for possible further processing.
      Challenge-Question Solutions

In the case where a prospect is viewing an ad, such as a webpage ad or a video ad, capturing biometric data may be difficult. Another method of authenticating the prospect is to show him a question or questions that only the real d-maker can answer and allow him to enter the answer(s) into the system. The answer(s) that the prospect give(s) is/are recorded in the acceptance record. Then, in the inspection process, an inspector can ask the real d-maker the same questions and the answers given can be checked. Some questions may not need to be checked with the real d-maker but with other sources.

The challenge-question technique will not work, of course, if the impersonator can contact the real d-maker in a short period of time and thereby get the answer from the real d-maker. But this technique may be better than nothing, especially if there is a time limit on how quickly the question(s) must be answered.

Accordingly, the invention can provide a method (or apparatus) for:
associating an EV payment contract with the exposure of a message to a recipient,
during the exposure, presenting challenge-question(s) that the real d-maker can answer,
capturing and storing the answer(s), and associating it with the EV payment contract,
if the recipient wins the EV payment bet, and claims the payoff, then in the inspection process:
   finding the stored answer(s)
   presenting the same question(s) to the claimant of the payoff,
   checking whether the recipient answered the question(s) correctly,
   if the recipient answered question(s) correctly, providing the payoff to claimant,
   if the recipient did not answer question(s) correctly, rejecting the claim
   storing the rejection for possible further processing.
      Memory Solution Methods

Another possible solution for determining whether the real d-maker was exposed to the seller's message, especially a visual message is to use his memory.

In this case, the person claiming the payoff will be the genuine-maker. But, the genuine d-maker will not have been exposed to the advertiser's message, if the genuine d-maker was impersonated when a user was receiving provisional EV payment.

So, the following procedure can be used in the inspection process to reveal the cheat. The payoff claimant is asked to recall the ad messages he purportedly viewed. If he cannot answer correctly, or answer some percentage of these memory questions correctly, his claim is rejected.

To be fair to the claimant, the SPQ-RB can aid the claimant's recall (allowing him to use “passive memory”) by including a process within the inspection process that shows him a selection of messages, some genuine ones that he purportedly saw and some false ones that he could not, and ask him to correctly identify the ones he saw.

Accordingly, the invention can provide for a method (or apparatus) for:
associating an EV payment with the exposure of a message by a recipient,
exposing a claimant to a set of messages, one of which he claims to have seen in the recipient process, the message associated with the claimant's winning EV payment bet, and some false messages that the claimant could not have seen,
asking the claimant to correctly identify the one he saw in the recipient process,
recording a claimant's answer(s) to the memory test question(s)
   if he answers incorrectly, recording that fact and rejecting his claim,
   if he answers correctly, recording that fact and validating his claim.

This method can be used with audio messages and conversation messages as well.

Terminal Authentication

Another method for deterring the impersonation cheat is to capture the IP number, cookie, phone number (or other identifying number) of the terminal that the recipient uses when he views an ad, or receives an audio message (including phone conversation).

In the inspection process, this identifying number can then be compared with the number of the terminal that the real d-maker uses. If there is a match, the claimant can be provided payoff. If there is a mismatch, the claimant's claim can be rejected.

Accordingly, the invention can provide a method (or apparatus) for:
in the recipient process, associating an EV payment with a terminal identifier the corresponds to the terminal that was used by the recipient as the means for being exposed to the required message,
in the inspection process, calling up the stored terminal identifier and checking whether claimant's terminal has a matching identifier,
if claimant's terminal does not have the same identifier, rejecting the claim
if claimant's does have the same identifier, validating the claim,
recording the results of the inspection.
   Sanction Solutions and Use of Affidavits

Another method for deterring the impersonation cheat is to discourage the real d-maker from taking part in the cheat by requiring that he sign an affidavit that he is not cheating, with the penalty being the possibility of a large fine or prison for fraud.

Thus, the SPQ-RB can include means for storing affidavits or references to them as part of a claim record.

There is a psychic cost to signing an affidavit if one is guilty of a cheat.

It is possible to ask co-workers of the d-maker to sign as witnesses as well, so that they would be implicated in a cheat.

To make the psychic cost harder to justify, the inventive method can include a “2-stage” EV payment bet process in which a recipient can win the “first stage” and then provide the affidavit in order to qualify for the second stage. The payoff for the first stage would be less than the payoff in the second stage. A second EV payment bet, a “parlay” bet, would be executed in which the recipient's probability of winning the second bet would be Payoff 1/Payoff 2.

Sanction solutions can deter any of the cheats described in this specification.

Whistleblower Solution Methods

Separately, it is possible to provide whistleblower incentives to people who would report a cheat. A whistleblower incentive can be used to deter any of the cheats mentioned in this specification.

The invention can provide for making this incentive even more effective. The main technique here is to delay transferring the payoff to a claimant, while advertising the facts of the provisional payoff. Whistleblowers who then have the time and knowledge to challenge the case for a payoff to the claimant.

The delay can be mediated via the SPQ-RB in two ways.
1. If the SPQ-RB does not handle payment transfer functionality, it will still pass payment authorization to a payment transfer entity. Thus, the SPQ-RB can delay this authorization by a period of time specified by default, or by the seller.
2. If the SPQ-RB does handle transfer functionality, it can delay the transfer itself.

(We note that SPQ-RB can provide for paying an interest rate during the delay period.)

Further, the SPQ-RB can make the facts of the RB offer and payoff available to potential whistleblowers via an online database. This “advertising” enables whistleblowers to seek out a potential payoff of their own, since they can see whether the claimant has cheated, according to the terms of the RB offer.

Accordingly, if the invention provides for whistleblowing, it can provide a method (or apparatus) for:
Registering the identity and/or contact data of a whistleblower,
Enabling a whistleblower to find all or part of the record of an RB offer, particularly the claim record,
Enabling a whistleblower to enter a protest to the payoff, and associating the protest with the payoff (associating the protest with the claim record); the protest possibly including a statement;
Registering a statement from the whistleblower (the statement may be entered by the whistleblower or by an inspector who has talked to the whistleblower);
Validating or rejecting the whistleblower's protest,
   If rejecting the protest, paying the whistleblower nothing
   If validating the protest, paying the whistleblower a reward and canceling or modifying the payoff, and storing the result of the protest in the claim record.

A whistleblower may be required to pay a fee for challenging the payoff. If so, the invention can also provide for enabling the whistleblower to pay the fee.

This whistleblower method can be used in other applications of the EV payment method where cheating may occur. (For example, the author of this specification plans to file an application for a method for tailoring discounts using EV payment. In this example case, cheating can occur, and the whistleblower method described above can be used.

This whistleblower method may be novel in the sense of delaying payment to a claimant until an whistleblower has a chance to challenge the payment, and in the sense of advertising the payoff terms and facts/justification such that whistleblowers can easily find the facts for authorizing payment and then challenge those facts.

### 6. Preventing a User from Exaggerating or Lying about his Role in a Purchase

The Problem

How to Prevent a User from Exaggerating or Lying About his Role in a Purchase?

A user who works for an organization, and uses his real name, may claim false credit for making/influencing a purchasing decision.

For example, assume that Paul, an executive in charge of purchasing computers, has an assistant, Abe. And assume that Abe, knowing about an upcoming computer purchase, accepts an RB offer for the purchase. Further, assume that the purchase occurs and that Abe's virtual EV payment is a winner, and Abe is provisionally owed the payoff. Finally, assume that Paul backs up Abe's story that Abe was the d-maker in the purchase.

This false credit cheat is easy to detect if people within an org want to expose the cheat. But, it is harder to detect if people in an org are in cahoots with the cheater, as they may be given a high payoff.

When we say false credit we do not mean an honest, subjective disagreement about the “quantity” of influence that a person has in a decision. Quantifying influence is itself a “false,” notion, for there is no objective way to measure influence. Still, people can come to some agreement on whether or not someone has influenced a decision at all, and on the relative “amounts” of influence people have had in a decision. So, while people will disagree, a recipient can blatantly exaggerate his influence, which is what we mean by false credit.

There are two general situations in which users can try to get away with the false credit cheat. We will treat them one at a time, describing methods for deterring these cheats.

Cheat Situation: When all the Material Decision Makers Have Accepted an RB Offer

In the first situation, all the material decision makers for a purchase have accepted an RB offer for that purchase.

For example, assume three people together make the decision about which mutual find family an org will select for its employees. Further, assume that all three of these people accept an RB offer from Janus Funds. Now, the three can try to cheat by waiting to see which one of them, if any, wins his EV payment bet. Then, if there is a winner, the other two users can say that this winning user was the primary decision maker (or the sole decision maker).

This cheat situation is not crippling because if all the d-makers have accepted a seller's RB offer, then the seller has achieved its objective—getting the important d-makers to be exposed to the seller's message.

The problem then devolves to dividing a payoff fairly—according to the terms of the RB offer.

Below, we describe several methods for preventing this cheat and methods for enabling multiple recipients to fairly divide a payoff.

Methods for Solving the False Credit Cheat

1. The primary method for deterring cheating is a thorough inspection using a variety of data (see sub-section 2d) as the starting point for determining a user's role in a purchase.
2. The sanction, affidavit and whistleblower methods described in Section 5 can also be used to deter the false credit cheat.
3. Another approach is to nullify the value of the extra EV payments that users try to receive through the false credit cheat. One method is to count all the EV payments for a purchase as one bet, one EV payment. So, for instance, if three recipients in an org have accepted the same RB offer, then the system can combine all the acceptances into a single acceptance, with the same EV. If this acceptance turns out to be a winner, the payoff is divided among the multiple recipients. Accordingly, the invention can provide a method (or apparatus) for combining multiple acceptances of a given RB offer by users associated with a single org, into one acceptance, one EV payment, that is, whose payoff is to be split among the recipients.
4. Another way to nullify the value of multiple EV payments is the following. If a user wins an EV payment bet, the system can check whether anyone else in the org has accepted the same offer. If multiple users have accepted the offer, the system can then wait before it alerts a winning user. The system can first alert all the recipients who have accepted the offer that one (or more) of the recipients has won. The system can then ask these recipients to describe their role in the purchasing decision in question. Once all the recipients have stated their role, the winning recipient can be revealed. This recipient will receive a portion of the payoff as specified by the terms of the offer, and his stated influence/role in the purchase (if his influence/role is verified).
5. A simpler way, perhaps, to deter the false credit cheat is to require that recipients describe their role in a purchase before accepting an RB offer about that purchase (technically, before any EV payment bet result is revealed). Then, a recipient is committed and there is little point in trying to falsely assign credit (provided all the material d-makers have accepted the RB offer).

But, what if the descriptions of multiple users add up to more than 100% influence in a purchase decision? For instance, what if there are three recipients and each says that his influence was 50%, adding up to 150% influence? There are many ways of handling this situation. For instance, the proportions of the descriptions can be used, so if each user claimed 50%, then the proportions would be 33.33% each. Or, the users can be queried to ask them to come to an agreement about their relative roles. The system can enable them to change their assessment of their roles.

Two or more recipients in an org who accept the same RB offer may not even realize it. There may be an honest disagreement over who is a d-maker for a purchase. Thus, the invention can provide a method (or apparatus) for alerting a user if someone else in his org has accepted the same RB offer that he as accepted.

Finding that someone else has accepted the same offer may cause a user to want to retract his acceptance or modify his statement of his role in the purchase.

Thus, and importantly, the invention can also provide a method (or apparatus) for enabling a user to rescind an acceptance and/or modify his assessment of his role.

Cheat Situation: When a/the Decision Maker Has not Accepted an RB Offer

In the second situation, one or more decision makers for a purchase has/have NOT accepted an RB offer for that purchase.

For example, assume that Paul is the key d-maker in an org for choosing a mutual fund for the org's employees. And assume that he does not care about accepting RB offers. That leaves an opening for his assistant, Abe, who accepts RB offers from fund companies and, let us further assume, wins a payoff stemming from an offer from CGM Funds. The problem for CGM Funds is that Paul is not exposed to CGM's advertising, and Abe who has been exposed has lied about his influence in the purchase.

This false credit cheat is far more important than the one in which all the d-makers have accepted an RB offer because this cheat prevents a seller from achieving its objective of having all the d-makers in an org be exposed to the seller's message.

Below, we describe methods for preventing the false credit cheat in this situation.

More Methods for Solving the False Credit Cheat

1. As discussed above, a thorough inspection is the primary deterrent.
2. As discussed, sanction, affidavit, and whistleblower methods can also be used as deterrents.
3. Another powerful deterrent is to register “verification” information, as described in sub-section 2d. It can be especially useful to require that a recipient enter a description of his role in a purchase before accepting an RB offer for that purchase. For example, if Abe is searching for RB offers from fund companies then he may be required before accepting these RB offers to enter an explanation of his role in any purchase from a fund company.
   As described previously, the SPQ-RB stores this verification information as part of the Abe's acceptance record and, possibly, as part of Abe's user profile. The problem for Abe and Paul (who is in cahoots with Abe) is that each lie that Abe tells is recorded and makes it more difficult for Paul to ever legitimately claim to be a d-maker for the products/services that Abe claims to be the d-maker for. Inconsistencies between Abe's a Paul's stated roles will arise. For instance, if Paul later accepts an RB offer and legitimately says he is the d-maker for mutual funds, then his statement conflicts with Abe's.
   Now, if Paul has no interest in ever in accepting RB offers, then it does not harm Paul to let Abe purport to have Paul's influence in purchases. But, if Paul wants to accept RB offers, he damages his ability each time he lets Abe falsely assume his role.

### 7. Associating EV Payments with a Specified Purchase

The Problem

Given Multiple Possible Purchases of the Same, or Very Similar, Product by an Org, and/or Multiple Possible ways to Accept an RB Offer, by Multiple People, at Multiple Times, how to Determine which EV Payments Legitimately Apply to a Given Purchase?

In using the invention, Sela's goal is to pay for the attention of the genuine d-maker(s) who decide on a particular purchase. Further, Sela does not want to pay a d-maker more than once for exposure to the same message. An obstacle to achieving these goals is associating a virtual EV payment—also called an RB offer acceptance—with the specified, actual purchase that Sela has defined/described. This “association problem” involves sub-problems that we will state below. After stating a sub-problem statement, will describe a solution method or methods that the invention can incorporate.

Matching Up Acceptances for the Same RB Offer

Let us assume that Sela offers to pay org realbuyers for their attention to a web page ad about the personal digital assistant (PDA) that Sela has for sale.

And let us assume that Paul can potentially accept this offer more than once, given the means that the invention uses to present RB offers to o-prospects.

Since Sela does not want to pay Paul more than once, the invention must be able to identify that his acceptances are for the same offer, or enable Sela to identify duplicate acceptances. The invention can then, by automated means, adjust for them (U.S. application Ser. No. 10/042,975 described certain methods for adjust for duplicate acceptances.)

Let's assume, first, that the invention enables users to accept Sela's offer by going to a web page and entering a unique code that identifies the offer.

In this case, if Paul accepts the offer more than once, the duplicate acceptances can easily be matched because they are identified by a unique code.

But, the problem becomes tougher when the system enables Sela to identify her offer by natural language descriptors and enables Paul to find the offers with those same descriptors. This kind of description is used when the invention is embodied as a directory in which sellers post their RB offers. O-prospects can then find the offers by entering search terms, such as PDA.

The reason natural language poses a problem is that Sela will often want to describe her offer—make it accessible—under various natural language descriptors. For example, she might use the following terms to describe and post her offer: personal digitial assistant, PDA, handheld, palmtop, digital organizer, Palm, Clie, Axim, iPaq, Pocket PC, etc.

Now, Paul can accept the offer using each of these terms. In some cases, there will be duplication. The term Clie and Axim may not constitute a duplicate acceptance, depending on the implementation. But generally speaking, the less specific the description, the greater the opportunity by Paul to fake which purchase the search term applies to. Thus, he may accept an offer under four terms, making four distinct acceptances. Assume he wins for one of those acceptances, then he can claim that the other three acceptances were for some other potential purchase.

This problem applies for a system that pays individual realbuyers too, not just org realbuyers. So, we will use a future patent application to describe solution methods for handling this problem and other problems that arise when using natural language to enable prospects to find RB offers.

Handling Acceptances that Occur at Different Times

D-makers in an org will accept Sela's RB offer at different times (pay attention to Sela's advertising at different times) which can lead to confusing about which purchase the acceptances apply to.

Let us assume that the subject of Sela's RB offer is a personal digital assistant (PDA) and that the terms of the offer stipulate that Paul must purchase the PDA within 10 days of being exposed to Sela's advertising. Further, assume that Paul, a genuine d-maker, accepts Sela's offer and views Sela's ad on January 1.

Further, assume that Frank, another d-maker in the same org, also accepts Sela's offer and views Sela's ad on January 5.
So, there are two presumably valid acceptances.
Assume that Paul does purchase a PDA on January 8.
Assume that Frank does not buy a PDA.
So, there is only one purchase.
And assume that Paul's acceptance is not a winner.
Assume that Frank's acceptance is a winner.
Paul and Frank can cheat by saying that Frank's winning acceptance applies to Paul's purchase of January 8.

The problem is that Paul and Frank have two acceptances—two EV payments—for a single purchase when they should only have one that applies to Paul's purchase.

(We are ignoring the possibility that both Paul and Frank are claiming to collaborate on the purchasing decision.)

A solution to this problem is for the system to wait until the stipulating time period for a purchase has expired on both acceptances (the general rule can be that for any acceptance the system waits until two time periods have expired before revealing its bet result).

Then, before revealing the results of the EV payment bet, the system, by automated means, asks the recipients who the d-maker is for each purchase. After the recipients declare who is responsible for each decision, the system reveals the results of the EV payment bets.

Each recipient will not be able to cheat because he will not know the results of the bets when he makes his declaration.

(The basics of this method can also be used to prevent cheating when multiple users from an org have accepted a realbuyer offer.)

Accepting RB Offers for the Same Purchase but for Different Types of Attention

The invention can enable Sela to pay for various kinds of attention, such as attention to a web page and/or a phone call. Sela may not want to allow Paul to get paid for more than one kind of attention. Thus, the terms of her offer may stipulate that Paul can only get paid for one kind of attention, although the kind of attention is up to him.

This problem exists in a system for paying individual realbuyers as well.

To enforce terms such as this, the invention will need to provide for matching up acceptances. So we have nothing to add here concerning solving this problem.

I've just won! Hey, does Anyone Have a Matching Purchase?

Let us imagine the following situation. Paul accepts Sela's offer to get paid for viewing an ad for a PDA that Sela is selling. Paul ends up not buying a PDA, but his EV payment turns out to be a winner. Now, says to a number of people in his org, “Hey, I just won an RB offer payment bet, do you know anyone in our org who bought a PDA within the past two weeks under our org's name?

If Paul finds such a person, he may be able to claim the payoff by using the proof-of-purchase for the purchase (which will include the org's name) even though Paul was not the d-maker for the purchase.

A thorough inspection may reveal this cheat. The inventor does not at this time know a simple way to prevent this cheat besides the use of the already described verification data as a starting point for a thorough inspection.

### 8. Enabling Confidential Payment to Org Realbuyers

An org realbuyer may want to keep the payments he receives confidential because his org, particularly if he works for a government, may require that he turn the payment in to the org, or because his co-workers might be jealous if he receives a large payoff, or for some other reason.

The invention can enable a recipient to request confidential payment and receive it.

Accordingly, in the recipient registration process, the invention can provide a method (or apparatus): for entering:
a request that payments to the recipient be made confidentially,
possibly, confidential contact data, i.e., an email address and/or a phone number,
possibly, a preference for how a payoff is to be confidentially transferred to him (confidential transfers of money are well-known).

Then, in the recipient acceptance process, the invention can tag all the recipient's acceptances with the request so that communication with the recipient can, possibly, be handled differently than it would be with open payment.

Then, in the recipient bet process, if the recipient wins an EV payment bet, the invention can provide for contacting the recipient at the confidential email address, or by some other equivalent confidential communication channel, such as a password protected website.

Then, in the inspection process, when an inspector calls up the recipient's winning acceptance, the acceptance will show that the recipient requires a confidential inspection.

Then, in the payoff transfer process, the invention can provide for transferring the payoff confidentially, as requested by the recipient, or as required by the invention's standard rules.

At first sight, a “confidential inspection” seems difficult to do effectively, but it may be possible, and in fact, may be the way many inspections are conducted. It is possible, for example, for an inspector to call an org and pose as a salesman for the product that the recipient says he bought. The inspector (posing as salesman) can then ask various people who the d-maker is for that product. If these people all say that the recipient is the d-maker, then those statements may be considered enough to validate the recipient as the genuine d-maker.

A confidential inspection may be harder to do if the seller is offering to pay d-makers who have a fractional influence in the purchase that the offer is about, and if more than one person in an org claims credit for making a purchasing decision. Trying to come to a judgment about what role a person had in an purchase may involve asking questions such as, How much influence does Paul have in this kind of purchase, which might tip people off to the true purpose of the inspection. Nevertheless, confidential inspections may be possible because an inspector posing a salesmen can ask a variety of natural questions about who in an org influences a purchasing decision.

A confidential inspection may cost more than a conventional inspection due to the research techniques used. It may cost more simply because it may entail higher, undetected fraud by recipients. This undetected fraud will presumably lead to lower sales conversion rates, and therefore, lower payments to recipients. These lower payments can come in the form of charging more for an inspection, or assessing recipients a fraud insurance premium. Hence, the invention can provide for charging the recipients more for an inspection if they choose a confidential one.

### 9. Broadening the Methods to Enable the Paying of Any Decision Maker

Most of the methods described above can be broadened to enable an advertiser to pay any decision maker who plays a specified decision making role in an org.

For example, an advertiser might want to pay for the attention of Congressional aides who contribute to the decision about voting for or against, say, ethanol subsidies.

As another example, an advertiser might want to pay for the attention of the managers in a city's administration who are in charge of the decisions about what playground equipment to put in a public park.

As another example, an advertiser might want to pay for the attention of a purchasing decision maker who is not necessarily making a purchase in a specified period of time, but who is in charge of specified purchasing decisions (as when a phone company wants to pay for the attention of the manager in charge of buying phone service for an org).

Not all the methods described above can be readily broadened, because some are special to paying realbuyers, as defined in this specification and in U.S. application Ser. No. 10/042,975.

Below we supply a set of terms that can be substituted for terms in the description above. These substitutions broaden the methods above so that they can be applied to paying any kind of decision maker who contributes to making any specified decision or kind of decision. The decision can be specified (described/defined) as broadly or narrowly as an advertiser desires.

Sometimes the substitutions we provide are not appropriate, as can easily be seen when one reads given parts of this specification. We leave it to the reader's common sense to determine where a substitution in this specification is appropriate or not.

Substitutions of Terms to Broaden the Methods Thus Far Disclosed

In each paragraph below, we first give a set of terms used above and then provide corresponding substitutions. In some cases we supply more than one substitution per set of terms because the alternative terms may allow for better sounding or more apt choices for substitution. There is no material difference usually in the alternatives.
Seller becomes advertiser.
Org realbuyer and realbuyer and the decision maker and d-maker become real decision maker or the decision maker or d-maker.
RB offer becomes real decision maker offer or RDM offer.
Purchasing decision and purchase decision and the purchase and particular product or service become named decision, defined decision, described decision, or type of decision or the decision.
Proof-of-purchase becomes proof-of-decision.

### 10. Using Definite Rather than EV Payments within the Methods Disclosed

The methods above employed virtual EV payment to provisionally pay a recipient who was then probabilistically inspected. The probability of inspection for a recipient was determined by the terms of the EV payment bet that the recipient engaged in.

A different method of payment using definite payment is also possible. This method was disclosed in various disclosure documents cited in the Cross-References section above. These disclosure documents are incorporated by reference.

In this method, realbuyers are still probabilistically verified, but through the following method:
1. a recipient who accepts a payment offer puts up an amount of money, called a bond, that he agrees will be forfeit if he is not a d-maker as he claims to be,
2. when the recipient accepts the offer, the system credits the recipient with a definite amount of money, rather than an EV payment,
3. with a pre-specified probability, a recipient is inspected to see if he has fulfilled the conditions of the pay-for-attention offer,
   a. if he passes the inspection, he keeps his payment and bond
   b. if he fails the inspection, he forfeits his payment and bond.

To create a larger penalty for a lying or exaggerating recipient, the definite payments made to him can be accumulated and held in escrow for some period of time (if he receives multiple payments). These escrowed payments would be forfeit as well upon a failed inspection that springs from a subsequent payment.

Other enhancements to this method were disclosed in the above-referenced disclosure documents, including steps that can eliminate the need for a bond to be put up by a recipient.

Thus, we do not mean to limit the method to the steps described above.

Those skilled in the art can readily see how to incorporate this definite payment method into the methods described in Sections 1-9 above:
In the seller process, the terms of a payment offer will differ in that an EV payment is not offered, but a definite one is. (The definite payment may or may not be subject to a discount formula, depending on the implementation.)
In the recipient process, an EV payment bet is not executed, but instead a definite payment is transferred to the recipient, and random selection is executed for determining whether the recipient is to be inspected or not (the probability of the recipient being selected for inspection is pre-determined).
In the inspection process, no payoff is transferred upon a successful inspection; there is a penalty assessed upon a failed inspection. (The cost of an inspection can be paid for in various ways, most likely perhaps, by assessing a fee per definite payment made. This fee can be transferred into a common pool for paying for inspections.)

Below we provide a mock claim for incorporating the definite payment method described in this Section 10 into the methods of application Ser. No. 10/042,975, and by extension into the methods of Sections 1-9 above. We note that a number of the methods of this specification can apply only when EV payments are used, but most methods can also apply where definite payments are used.

The method is a method for using a computer to enable a user, called a seller, to pay targeted users for their attention to a message, comprising:
(a) a seller process for entering into the computer an offer stipulating that recipients who accept the offer will be owed a specified amount of money if they pay attention to a specified ad message, and if they satisfy a set of at least one target audience characteristics,
(b) said characteristics stated as a set of offer conditions by said advertiser,
(c) at least one of said conditions stating that to be eligible for payment, a recipient must purchase a product or service that is the subject of the offer within a specified period of time,
(d) presenting an interface to the public for enabling anyone to access and accept said offer,
(e) a recipient process for registering acceptance of said offer by a user, called a recipient, said acceptance entailing:
   e1. registering the recipient's identity and,
   e2. registering that the recipient has entered a request to be exposed to said specified message,
   e3. accepting from said recipient an amount of money called a Bond to be held in a system controlled recipient's bank account,
(f) after registering said acceptance:
   f1. transferring said amount of money to said bank account for the recipient,
   f2. executing a random selection in which the recipient has a predetermined probability of being selected for an inspection,
(g) if, and only if, said recipient is selected, passing the selection result to an inspection process for determining whether said recipient satisfies said offer conditions,
(h) based only upon a negative determination by said inspection process, notifying a payment process for confiscating the Bond from said recipient's bank account.

1. a method for using a computer to enable a user, called a seller, to pay targeted users for their attention to a message, comprising:
(a) a seller process for entering into the computer an offer stipulating that recipients who accept the offer will be owed a specified amount of money if they pay attention to a specified ad message, and if they satisfy a set of at least one target audience characteristics,
(b) said characteristics stated as a set of offer conditions by said advertiser,
(c) at least one of said conditions stating that to be eligible for payment a recipient must be a decision maker who influences the purchase by an organization of a specified product or service that is the subject of the offer,
(d) said amount of money being a specified expected value (EV),
(e) presenting an interface to the public for enabling anyone to access and accept said offer,
(f) a recipient process for registering acceptance of said offer by a user, called a recipient, said acceptance entailing:
e 1. registering the recipient's identity and,
e2. registering that the recipient has entered a request to be exposed to said specified message,
(g) said EV being paid via an EV payment bet including a Payoff,
(h) after registering said acceptance, executing said EV payment bet for said recipient with the probability of said recipient winning set at EV/Payoff,
(i) if, and only if, said recipient wins said bet, passing the winning result to an inspection process for determining whether said recipient satisfies said offer conditions,
(j) based only upon a positive determination by said inspection process, notifying a payment process for providing the Payoff to said recipient,
whereby a seller pays a specified amount of money only to qualified, targeted recipients who influence specified purchasing decision for an organization in exchange for their attention to a specified message.
